(19) United States
(12) Patent Application Publication
(10) Pub. No.: US 2022/0188975 A1
(43) Pub. Date: Jun. 16, 2022

(54) IMAGE CONVERSION DEVICE, IMAGE CONVERSION MODEL LEARNING DEVICE, METHOD, AND PROGRAM

(71) Applicant: NIPPON TELEGRAPH AND TELEPHONE CORPORATION, Tokyo (JP)

(72) Inventors: Yukito WATANABE, Tokyo (JP); Kaori KUMAGAI, Tokyo (JP); Takashi HOSONO, Tokyo (JP); Jun SHIMAMURA, Tokyo (JP); Atsushi SAGATA, Tokyo (JP)

(73) Assignee: NIPPON TELEGRAPH AND TELEPHONE CORPORATION, Tokyo (JP)

(21) Appl. No.: 17/604,307

(22) PCT Filed: Apr. 20, 2020
(86) PCT No.: PCT/JP2020/017068

§ 371 Date: Oct. 15, 2021

(30) Foreign Application Priority Data
Apr. 19, 2019 (JP) 2019-080429

(51) Int. Cl. G06T 3/40

(52) U.S. Cl. CPC G06T 3/4053; G06T 3/4046; G06T 3/4007

(57) ABSTRACT

A low-resolution image can be converted into a high-resolution image in consideration of differential values of the images.

A learning conversion unit 22 inputs a first image for learning to a conversion processing model for converting the first image into a second image having a higher resolution than the first image to acquire the second image for learning corresponding to the first image for learning. Then, a differential value calculation unit 24 calculates a differential value from the acquired second image for learning, and calculates a differential value from a correct second image corresponding to the first image for learning. Then, the learning unit 26 causes the conversion processing model to learn by associating the calculated differential value of the second image for learning with the differential value of the correct second image.

### TECHNICAL FIELD

The present invention relates to an image conversion apparatus, and image conversion model learning apparatus, method, and program.

### BACKGROUND ART

In recent years, with the spread of compact imaging devices such as smartphones, there has been an increasing demand for technologies in which images of any object are taken in various locations or environments to recognize objects in the taken images.

Various techniques for recognizing objects in images have been invented and disclosed. For example, a similar image acquisition apparatus in the related art acquires, for an image input as a query, an image including the same object from reference images registered in advance (for example, see Patent Literature 1).

The similar image acquisition apparatus first detects a plurality of characteristic partial regions from an image, and represents a feature of each partial region as a feature vector consisting of real or integer values. This feature vector is commonly referred to as a “local feature”. As for the local feature, scale invariant feature transform (SIFT) (see, for example, Non Patent Literature 1) is often used.

Then, the similar image acquisition apparatus compares the feature vectors of the partial regions included in two different images with each other to determine the sameness between the feature vectors. When the number of feature vectors having a high degree of similarity is large, it is likely that the two compared images include the same object. On the contrary, when the number of feature vectors having a high degree of similarity is small, it is unlikely that the two compared images include the same object.

In this way, the similar image acquisition apparatus described in Patent Literature 1 can construct a reference image database that stores images (reference images) including an object to be recognized, and searches for a reference image that contains the same object as an object in a newly input image (query image) to identify the object present in the query image. Thus, the similar image acquisition apparatus described in Patent Literature 1 can calculate one or more local features from images and determine the sameness between the images for each partial region to find an image including the same object.

However, when the resolution of the query images or the reference image is low, the accuracy of the image search disadvantageously decreases. One cause of the decrease in the search accuracy is that as the difference between the resolutions of the query image and the reference images is larger, it is more likely to acquire different local features from the query image and the correct reference image. Another cause of the decrease in the search accuracy is that as the resolution of the query image or the reference images is lower, it is less likely to acquire the local feature that can sufficiently identify objects included in the images.

For example, when each of high-resolution reference images is searched using a low-resolution image as the query image, high frequency components are often lost from the low-resolution query image, causing the above-mentioned problems.

In such a case, when the resolutions of the images are made uniform by decreasing the resolution of the high-resolution images, the difference in resolution is resolved but a lot of detailed information is lost. As a result, the local features of different images become similar, failing to sufficiently improve the search accuracy. As such, several techniques that restore high frequency components in the low-resolution image have been proposed and disclosed.

For example, learning super-resolution (for example, see Non Patent Literature 2) is known. The learning super-resolution is a method of converting a low-resolution image into a high-resolution image using a convolutional neural network (CNN). In the learning super-resolution image disclosed in Non Patent Literature 2, the CNN for converting a low-resolution image into a high-resolution image is learned by using a pair of any low-resolution image and a correct high-resolution image acquired by increasing the resolution of the low-resolution image. Specifically, the CNN for converting a low-resolution image into a high-resolution image is acquired by setting a mean squared error (MSE) between a pixel value of the high-resolution image acquired by the CNN and a pixel value of the correct high-resolution image as a loss function and learning the CNN. By using the learned CNN to convert a low-resolution image into a high-resolution image, high frequency components that are not included in the low-resolution image are accurately restored.

### CITATION LIST

### Patent Literature

Patent Literature 1: JP 2017-16501 A

### Non Patent Literature

Non Patent Literature 1: D. G. Lowe, “Distinctive Image Features from Scale-Invariant Keypoints, International Journal of Computer Vision”, pp. 91-110, 2004
Non Patent Literature 2: C. Dong, C. C. Loy, K. He, and X. Tang, “Image Super-resolution Using Deep Convolutional Networks”, In CVPR, 2014

### SUMMARY OF THE INVENTION

### Technical Problem

However, there is a problem that the learning super-resolution disclosed in Non Patent Literature 2 described above does not necessarily improve the local features extracted during image search.

For example, in the SIFT described in Non Patent Literature 1 described above, the feature vector, which is the local feature, is calculated according to magnitude and orientation of the gradient of the image. On the contrary, the MSE set as the loss function in Non Patent Literature 1 described above serves to reduce an error between a pixel value of each pixel of the high-resolution image converted by the CNN and a pixel value of each pixel of the correct high-resolution image, and does not necessary reduce an error in magnitude and orientation of the gradient of the local feature. Thus, similar local features are not necessarily acquired from the high-resolution image acquired by the CNN and the correct high-resolution image, such that the search accuracy is not sufficiently improved.

The present invention is made in light of the foregoing, an object of the present invention is to provide image conversion apparatus, method, and program that for converts a low-resolution image into a high-resolution image in consideration of differential values of the images.

In addition, an object of the present invention is to provide an image conversion model learning apparatus, method, and program that acquire a conversion processing model for converting a low-resolution image into a high-resolution image in consideration of differential values of the images.

### Means for Solving the Problem

In order to achieve the above-mentioned object, an image conversion apparatus from a first aspect of the invention is an image conversion apparatus for converting a first image into a second image having a higher resolution than the first image, the apparatus including: an acquisition unit configured to acquire a first image to be converted; and a conversion unit configured to input the first image to be converted acquired by the acquisition unit to a conversion processing model for converting the first image into the second image, the conversion processing model being previously learned by associating a differential value acquired from a second image for learning output by inputting a first image for learning to the conversion processing model with a differential value acquired from a correct second image corresponding to the first image for learning to acquire the second image corresponding to the first image to be converted.

Further, in the image conversion apparatus, the conversion processing model may be a model previously learned so as to reduce a loss function represented as a difference between the differential value of the second image for learning and the differential value of the correct second image corresponding to the first image for learning.

An image conversion model learning apparatus from a second aspect of the invention includes: a learning conversion unit configured to input a first image for learning to a conversion processing model for converting a first image into a second image having a higher resolution than the first image to acquire a second image for learning corresponding to a first image for learning; a differential value calculation unit configured to calculate a differential value from the second image for learning acquired by the learning conversion unit and calculate a differential value of a correct second image corresponding to the first image for learning; and a learning unit configured to cause the conversion processing model to learn by associating the differential value of the second image for learning calculated by the differential value calculation unit, with the differential value of the correct second image calculated by the differential value calculation unit.

In the image conversion model learning apparatus, the learning unit may cause the conversion processing model to learn so as to reduce a loss function represented as a difference between the differential value of the second image for learning and the differential value of the correct second image.

An image conversion method from a third aspect of the invention is an image conversion method for converting a first image into a second image having a higher resolution than the first image, the method including, at a computer: acquiring a first image to be converted; and inputting the acquired first image to be converted to a conversion processing model for converting the first image into the second image, the conversion processing model being previously learned by associating a differential value acquired from a second image for learning output by inputting a first image for learning to the conversion processing model with a differential value acquired from a correct second image corresponding to the first image for learning to acquire the second image corresponding to the first image to be converted.

An image conversion model learning method from a fourth aspect of the invention is an image conversion model rearming method including, at a computer: inputting a first image for learning to a conversion processing model for converting a first image into a second image having a higher resolution than the first image to acquire a second image for learning corresponding to the first image for learning; calculating a differential value from the acquired second image for learning and calculating a differential value of a correct second image corresponding to the first image for learning; and causing the conversion processing model to learn by associating the calculated differential value of the second image for learning with the calculated differential value of the correct second image.

A program from a fifth aspect of the invention is a program for converting a first image into a second image having a higher resolution than the first image, the program causing a computer to: acquire a first image to be converted; and input the acquired first image to be converted to a conversion processing model for converting the first image into the second image, the conversion processing model being previously learned by associating a differential value acquired from a second image for learning output by inputting a first image for learning to the conversion processing model with a differential value acquired from a correct second image corresponding to the first image for learning to acquire the second image corresponding to the first image to be converted.

A program from a sixth aspect of the invention is a program causing a computer to: input a first image for learning to a conversion processing model for converting a first image into a second image having a higher resolution than the first image, to acquire a second image for learning corresponding to the first image for learning; calculate, a differential value from the acquired second image for learning and calculating a differential value of a correct second image corresponding to the first image for learning; and cause the conversion processing model to learn by associating the calculated differential value of the second image for learning with the calculated differential value of the correct second image.

### Effects of the Invention

The image conversion apparatus, method, and program according to the present invention can advantageously convert a low-resolution image into a high-resolution image in consideration of differential values of the images.

The image conversion model learning apparatus, method, and program can advantageously acquire a conversion processing model for converting a low-resolution image into a high-resolution image in consideration of differential values of the images.

### BRIEF DESCRIPTION OF DRAWINGS

FIG. 1 is a block diagram illustrating the configuration of an image conversion model learning apparatus according to a embodiment.

FIG. 2 are diagrams illustrating examples of a filter for calculating a differential value.

FIG. 3 is a block diagram illustrating the configuration of an image conversion apparatus according to the embodiment.

FIG. 4 is a flowchart illustrating of an image conversion model learning processing routine performed in the image conversion model learning apparatus according to the embodiment.

FIG. 5 is a flowchart illustrating an image conversion processing routine performed in the image conversion apparatus according to the embodiment.

### DESCRIPTION OF EMBODIMENTS

Hereinafter, embodiments of the present invention will be described in detail with reference to the drawings.

Configuration of Image Conversion Model Learning Apparatus According to Embodiment

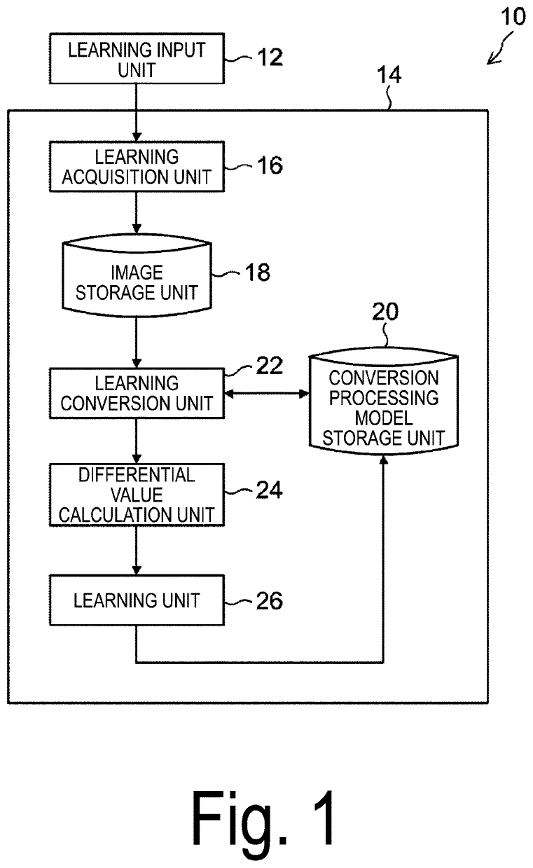

FIG. 1 is a block diagram illustrating an example of the configuration of an image conversion model learning apparatus 10 according to a embodiment. The image conversion model learning apparatus 10 is configured of a computer provided with a central processing unit (CPU), a graphics processing unit (GPU), a random access memory (RAM), and a read only memory (ROM) that stores a program for executing a below-mentioned image conversion model learning processing routine. The image conversion model learning apparatus 10 functionally includes a learning input unit 12 and a learning computing unit 14.

The image conversion model learning apparatus 10 according to the embodiment produces a conversion processing model for converting a low-resolution first image into a second image having a higher resolution than the first image.

The learning input unit 12 receives a plurality of data, which are pairs of a first image I_{L} for learning and a correct second image I_{H}. The correct second image I_{H} is any image, and the first image I_{L} for learning is a low-resolution image acquired by decreasing the resolution of the corresponding correct second image

The first image I_{L} for learning can be created, for example, by lower resolution processing in the related art. For example, the first image I_{L} for learning is created by reducing the correct second image I_{H} according to an existing approach, the Bicubic method. In the following, one first image I_{L} for learning and one correct second image I_{H} are handled as one pair of data. The second image I_{H} described herein is a high-resolution image acquired by increasing the resolution of the first image I_{L} for learning.

As illustrated in FIG. 1, the learning computing unit 14 includes a learning acquisition unit 16, an image storage unit 18, a conversion processing model storage unit 20, a learning conversion unit 22, a differential value calculation unit 24, and a learning unit 26.

The learning acquisition unit 16 acquires each of the plurality of data received by the learning input unit 12, and stores the acquired data in the image storage unit 18. The image storage unit 18 stores the plurality of data that are pairs of the first image I_{L} for learning and the correct second image I_{H}.

The conversion processing model storage unit 20 stores parameters of a conversion processing model for converting the low-resolution first image into the high-resolution second image having a higher resolution than the first image.

In the embodiment, the case where the convolutional neural network (CNN) is used as the conversion processing model is described as an example. For this reason, the conversion processing model storage unit 20 stores parameters of the convolutional neural network (hereinafter simply referred to as “CNN”).

The CNN in the embodiment is the CNN that increases the resolution of an input image and outputs the high-resolution image. The layer configuration of the CNN is any configuration in the related art. In the embodiment, the layer configuration described in Non Patent Literature 3 described below is used.

Non Patent Literature 3: M. Haris, G. Shakhnarovich, and N. Ukita, “Deep Back-Projection Networks for Super-resolution”, In CVPR, 2018

The learning conversion unit 22 inputs each of the first images I_{L} for learning stored in the image storage unit 18 to the CNN to acquire each of the second images I_{S} for learning corresponding to the input first images I_{L} for learning.

Specifically, first, the learning conversion unit 22 reads the CNN parameters stored in the conversion processing model storage unit 20. Next, the learning conversion unit 22 reflects the read parameters on the CNN to configure the CNN for performing image conversion.

Next, the learning conversion unit 22 reads each of the first images I_{L} for learning stored in the image storage unit 18. Then, the learning conversion unit 22 inputs each of the first images I_{L} for learning to the CNN to produce each of the second images I_{S} for learning corresponding to the first image I_{L} for learning. This produces a plurality of pairs of the first image I_{L} for learning and the second image I_{S} for learning. Here, a high-resolution image acquired by increasing the resolution of the first image I_{L} for learning is the second image I_{S}. The correct second image I_{H} is a high-resolution image that is an original image of the low-resolution first image I_{L} for learning. Thus, the correct second image I_{H} and the first image I_{L} for learning are considered to be training data for learning the parameters of the CNN.

Note that the higher resolution of the image according to the embodiment is performed by convoluting an input image using the CNN having the configuration described in Non Patent Literature 3, but the method is not limited thereto and any convolution method using the neural network may be adopted.

The differential value calculation unit 24 calculates a differential value from each of the second images I_{S} for learning produced by the learning conversion unit 22. The differential value calculation unit 24 reads the correct second images I_{H} corresponding to the first images I_{L} for learning from the image storage unit 18, and calculates a differential value from each of the correct second images I_{H}. Note that when the image to be processed has three channels, the differential value calculation unit 24 applies publicly-known gray-scale processing on the image, and calculates a differential value of the image integrated into one channel.

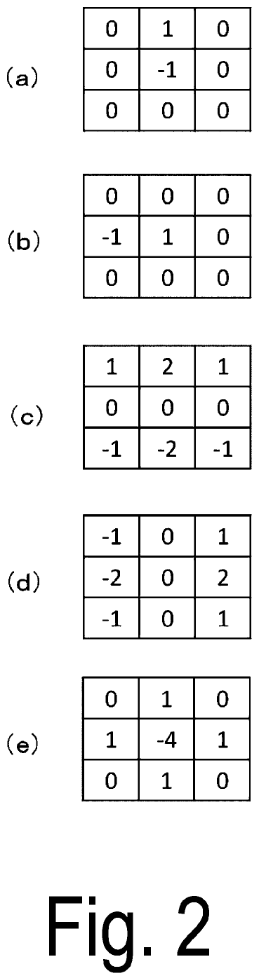

The differential value calculation unit 24 outputs, for example, each of a horizontal differential (difference) value and a vertical differential (difference) value of the image, as the differential value. The differential value calculation unit 24 outputs, for example, a difference between a focused pixel and a pixel on the right of the focused pixel and a difference between the focused pixel and the pixel under the focused pixel, as differential values. In this case, for example, it is preferable to calculate the differential value by applying convolutional processing using a differential filter as illustrated in FIGS. 2(a) and 2(b) to the image. Note that FIG. 2(a) is a vertical differential filter, and FIG. 2(b) is a horizontal differential filter.

Alternatively, the differential value calculation unit 24 may calculate the differential value by applying convolutional processing using a Sobel filter as illustrated in FIGS. 2(c) and 2(d) to the image. In the case of using the Sobel filter as illustrated in FIGS. 2(c) and 2(d), processing time increases, but noise effects can be suppressed.

Note that the differential value calculated by the differential value calculation unit 24 is not limited to a first-order differential value, and the differential value calculation unit 24 may output a value acquired by repeating differentiation any number of times as a differential value.

For example, the differential value calculation unit 24 may calculate and output a second-order differential value by applying convolutional processing using a Laplacian filter as illustrated in FIG. 2(e) to the image. In addition, the differential value calculation unit 24 may calculate the differential value by applying convolutional processing using a Laplacian of Gaussian filter described in Non Patent Literature 1 described above to the image.

In the embodiment, the case where the differential value calculation unit 24 calculates the first-order differential value and the second-order differential value from each image is described as an example.

The processing of the differential value calculation unit 24 yields the differential value of the second image I_{S} for learning produced from the first image I_{L} for learning by the learned CNN, and the differential value of the correct second image I_{H} with respect to the first image I_{L} for learning.

The learning unit 26 learns the CNN parameters by associating the differential value of the second image I_{S} for learning and the differential value of the correct second image I_{H}, which are calculated by the differential value calculation unit 24, with each other.

Specifically, the learning unit 26 learns the CNN parameters so as to reduce a loss function described below. The loss function described herein is expressed as the difference between the differential value of the second image I_{S} for learning corresponding to the first image I_{L} for learning and the differential value of the correct second image I_{H} corresponding to the first image I_{L}.

As described above, the differential value is not limited to one type, and two or more types of differential values may be used. In addition to the differential value, a difference between a pixel value of the correct second image I_{H} and a pixel value of the second image I_{S} for learning may be included in the loss function. In the embodiment, the case where the loss function is calculated from pixel values, first-order differential values, and second-order differential values of the correct second image I_{H} and the second image I_{S} for learning is described as an example.

Specifically, the learning unit 26 learns the CNN parameters to minimize the loss function of Expression (1) described below. Then, the learning unit 26 optimizes the CNN parameters.

λ∥I_{H}−I_{S}∥₁+λ₂(∥∇ₓI_{H}−∇ₓI_{S}∥₁+∥∇_{y}I_{H}−∇_{y}I_{S}∥₁)+λ₃(∥∇²I_{H}−∇²I_{S}∥₁) [Math. 1]

I_{H} in Expression (1) described above represents a pixel value of the correct high-resolution second image. I_{S} in Expression (1) described above represents a pixel value of the second image for learning output when the first image I_{L} for learning is input to the CNN

In addition, ∇ₓI in Expression (1) represents a horizontal first-order differential value of the image I, and ∇_{y}I represents a vertical first-order differential value in the vertical direction of the image I. In addition, ∇²I in Expression (1) represents a second-order differential value of the image I. ∥·∥I represents L1 regularization. λ1, λ2, λ3 are parameters of weight and use any real number such as 0.5.

As illustrated in Expression (1) described above, the loss function in the embodiment is expressed as a difference in pixel values, a difference in first-order differential values, and a difference in second-order differential values between the correct second image I_{H} and the second image I_{S} for learning. The learning unit 26 updates all CNN parameters using an error back propagation method so as to reduce the loss function illustrated in Expression (1). This optimizes the CNN parameters such that the local features based on the differential values extracted from the images become similar between the differential value of the correct second image I_{H} and the differential value of the second image I_{S} for learning.

Note that the loss function may include other terms as long as the terms include differential value of the image. For example, the loss function may be represented as an expression in which content loss, adversarial loss, and the like described in Non Patent Literature 4 are added to the Expression (1) described above.

Non Patent Literature 4: C. Ledig, L. Theis, F. Husz′ar, J. Caballero, A. Cunningham, A. Acosta, A. P. Aitken, A. Tejani, J. Totz, Z. Wang et al., Photorealistic Single Image Super-resolution Using a Generative Adversarial Network, In CVPR, 2017

The learning unit 26 stores the parameters of the learned CNN in the conversion processing model storage unit 20. This results in parameters of the CNN for converting a low-resolution image into a high-resolution image in consideration of the differential values of the images.

For example, in performing image search, when the resolution of the query image is low or the resolution of each of the reference images stored in the database to be searched is low, the low-resolution image may be converted into a high-resolution image by the CNN.

Consider, for example, the case where the query image is a low-resolution image and each of the reference images is a high-resolution image. In this case, for example, the query image is converted into a high-resolution image by the CNN. At this time, similar local features are not necessarily extracted from the high-resolution image acquired by the conversion processing of the CNN and the high-resolution image corresponding to each of the reference images. Thus, even if the query image is converted into the high-resolution image by the CNN, the search accuracy may not be improved.

In contrast, the image conversion model learning apparatus 10 according to the embodiment converts the low-resolution first image I_{L} for learning into a high-resolution image by the CNN to acquire the second image I_{S} for learning. Then, the image conversion model learning apparatus 10 in the embodiment causes the CNN to learn according to a below-mentioned procedure. Here, first, the differential value is calculated from the second image I_{S} for learning. Next, a differential value is calculated from the correct high-resolution second image I_{H} corresponding to the first image I_{L} for learning. Then, the CNN is caused to learn so as to reduce a difference between the differential value of the second image I_{S} for learning and the differential value of the correct second image I_{H}. This acquires parameters of the CNN that performs image conversion in consideration of the differential values extracted from the images. Thus, the learned CNN converts a low-resolution image into a high-resolution image in consideration of the differential values of the images. In this manner, for example, in searching an object included in a low-resolution image, it is possible to acquire CNN parameters that enable image conversion for appropriately extracting the local feature based on the differential value.

### Configuration of Image Conversion Apparatus According to Embodiment

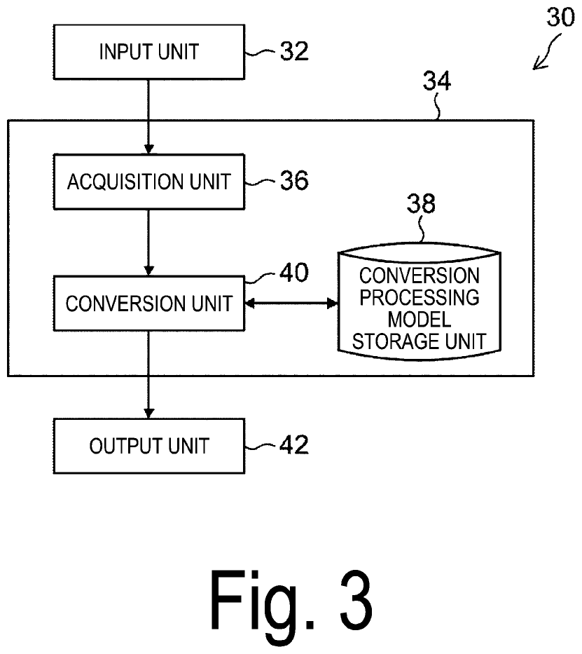

FIG. 3 is a block diagram illustrating an example of the configuration of an image conversion apparatus 30 according to the embodiment. The image conversion apparatus 30 is configured of a computer provided with a central processing unit (CPU), a graphics processing unit (GPU), a random access memory (RAM), and a read only memory (RAM) that stores a program for executing a below-mentioned image conversion processing routine. The image conversion apparatus 30 functionally includes an input unit 32, a computing unit 34, and an output unit 42. The image conversion apparatus 30 converts a low-resolution image to a high-resolution image using the learned CNN.

The input unit 32 acquires a first image to be converted. The first image is a low-resolution image.

As illustrated in FIG. 3, the computing unit 34 includes an acquisition unit 36, a conversion processing model storage unit 38, and a conversion unit 40.

The acquisition unit 36 acquires the first image to be converted received by the input unit 32.

The conversion processing model storage unit 20 stores the parameters of the CNN learned by the image conversion model learning apparatus 10.

The conversion unit 40 reads the parameters of the learned CNN, which are stored in the conversion processing model storage unit 38. Next, the learning conversion unit 22 reflects the read parameters on the CNN, and configures the learned CNN.

Then, the conversion unit 40 inputs the first image to be converted acquired by the acquisition unit 36 to the learned CNN to acquire a second image corresponding to the first image to be converted. The second image is an image having a higher resolution than the input first image, and is acquired by increasing the resolution of the input first image.

The output unit 42 outputs the second image acquired by the conversion unit 40 as a result. The second image thus acquired is an image converted in consideration of the differential values extracted from the images.

Actions of Image Conversion Apparatus and Image Conversion Model Learning Apparatus According to Embodiment

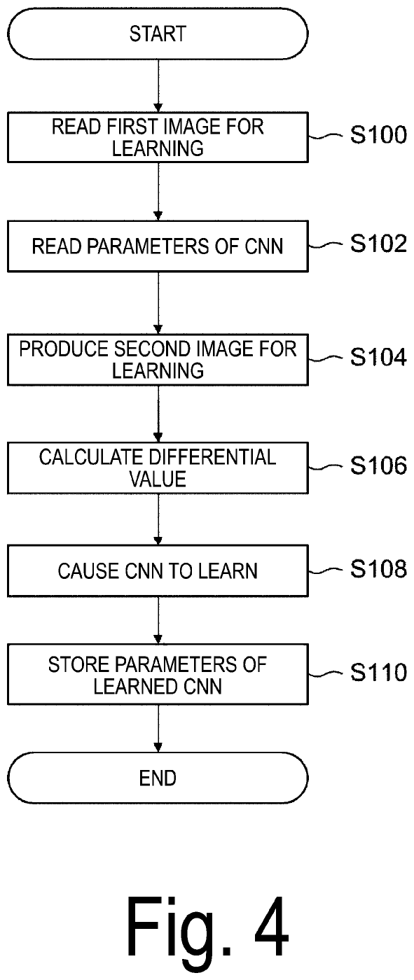

Next, actions of the image conversion apparatus 30 and the image conversion model learning apparatus 10 according to the embodiment are described. First, the actions of the image conversion model learning apparatus 10 are described using a flowchart shown in FIG. 4.

Image Conversion Model Learning Processing Routine

First, the learning input unit 12 receives a plurality of data that are pairs of the first image I_{L} for learning and the correct second image I_{H}. Next, the learning acquisition unit 16 acquires each of the plurality of data received by the learning input unit 12 and stores the acquired data in the image storage unit 18. Then, when the image conversion apparatus 30 receives an instruction signal to start learning processing, an image conversion model learning processing routine illustrated in FIG. 4 is executed.

In Step S100, each of the first images I_{L} for learning stored in the image storage unit 18 is read.

In Step S102, the learning conversion unit 22 reads CNN parameters stored in the conversion processing model storage unit 20. Next, the learning conversion unit 22 configures the CNN that performs image conversion based on the read parameters.

In Step S104, the learning conversion unit 22 inputs each of the first images I_{L} for learning read in Step S100 to the CNN to produce each of the second images I_{S} for learning corresponding to the first images I_{L} for learning.

In Step S106, the differential value calculation unit 24 calculates a differential value from each of the second images I_{H} for learning produced in Step S104. The differential value calculation unit 24 reads the correct second images I_{H} corresponding to the first images I_{L} for learning read in Step S100 from the image storage unit 18, and calculates a differential value from each of the correct second images I_{H}.

In Step S108, the learning unit 26 learns the CNN parameters so as to minimize the loss function of equation (1) described above based on the differential value of the second image I_{S} for learning and the differential value I_{H} of the correct second image, which are calculated in Step S106.

In Step S110, the learning unit 26 stores the parameters of the learned CNN acquired in Step S108 in the conversion processing model storage unit 20, and terminates the processing of the image conversion model learning processing routine.

This results in the parameters of the CNN that performs image conversion in consideration of the differential values extracted from the images.

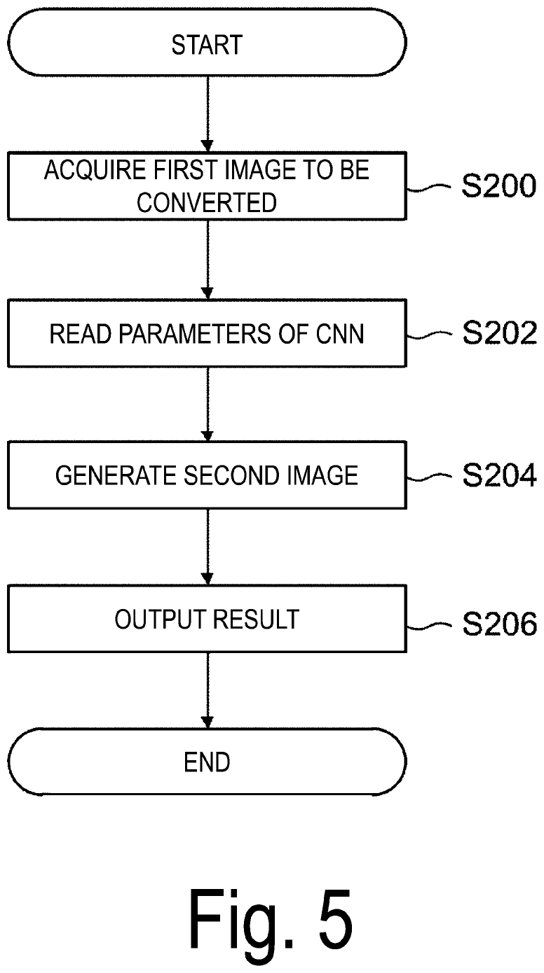

Next, the actions of the image conversion apparatus 30 are described using a flowchart shown in FIG. 5.

Image Conversion Processing Routine

When the first image to be converted is input to the image conversion apparatus 30, the image conversion apparatus 30 executes the image conversion processing routine illustrated in FIG. 5.

In Step S200, the acquisition unit 36 acquires the input first image to be converted.

In Step S202, the conversion unit 40 reads parameters of the learned CNN, which are stored in the conversion processing model storage unit 20. Next, the conversion unit 40 reflects the read parameters on the CNN, and configures the learned CNN.

In Step S204, the conversion unit 40 inputs the first image to be converted acquired in Step S200 to the learned CNN acquired in Step S202, to acquire a second image corresponding to the first image to be converted. The second image is an image having a higher resolution than the input first image, and is acquired by increasing the resolution of the input first image.

In Step S206, the output unit 42 outputs the second image acquired in Step S204 as a result, and terminates the image conversion processing routine.

As described above, the image conversion model learning apparatus in the embodiment inputs the first image for learning to the CNN for converting the first image for learning into the second image having a higher resolution than the first image, to acquire the second image for learning corresponding to the first image for learning. Then, the image conversion model learning apparatus calculates the differential value from the second image for learning, and calculates the differential value from the correct second image corresponding to the first image for learning. Then, the image conversion model learning apparatus causes the CNN to learn by associating the differential value of the second image for learning with the differential value of the correct second image. This can acquire the conversion processing model for converting the low-resolution image into the high-resolution image in consideration of the differential values of the images.

The image conversion apparatus in the embodiment inputs the first image to be converted into the CNN learned as follows to acquire a corresponding second image. The CNN is learned in advance by associating the differential value acquired from the second image for learning with the differential value acquired from the correct second image. Here, the second image for learning is acquired by inputting the first image for learning to the CNN. As a result, the low-resolution image can be converted into the high-resolution image in consideration of the differential values of the images.

In addition, in searching for an object included in the low-resolution image, it is possible to execute the conversion processing from the low-resolution image to the high-resolution image, which can appropriately extract the local features corresponding to differential values. Since the low-resolution image is converted into the high-resolution image in consideration of the differential values in searching for an object in the low-resolution image from the high-resolution image, a local feature for accurately acquiring a search result can be extracted from the high-resolution image.

In addition, in searching for an object included in the low-resolution image, the CNN that is an example of a neural network can be learned as the conversion processing model for performing conversion processing of appropriately extracting a local feature corresponding to a differential value.

Note that the present invention is not limited to the above-described embodiment, and various modifications and applications may be made without departing from the gist of the present invention.

### REFERENCE SIGNS LIST

10 Image conversion model learning apparatus
12 Learning input unit
14 Learning computing unit
16 Learning acquisition unit
18 Image storage unit
20 Conversion processing model storage unit
22 Learning conversion unit
24 Differential value calculation unit
26 Learning unit
30 Image conversion apparatus
32 Input unit
34 Computing unit
36 Acquisition unit
38 Conversion processing model storage unit
40 Conversion unit
42 Output unit

1. An image conversion apparatus for converting a first image into a second image having a higher resolution than the first image, the apparatus comprising:
an acquire configured to acquire a first image to be converted; and
a converter configured to input the first image to be converted acquired by the acquire to a conversion processing model for converting the first image into the second image, the conversion processing model being previously learned by associating a differential value acquired from a second image for learning output by inputting a first image for learning to the conversion processing model with a differential value acquired from a correct second image corresponding to the first image for learning to acquire the second image corresponding to the first image to be converted.

2. The image conversion apparatus according to claim 1, wherein
the conversion processing model includes a model previously learned so as to reduce a loss function represented as a difference between the differential value of the second image for learning and the differential value of the correct second image corresponding to the first image for learning.

3. An image conversion model learning apparatus comprising:
a learning converter configured to input a first image for learning to a conversion processing model for converting a first image into a second image having a higher resolution than the first image to acquire a second image for learning corresponding to the first image for learning;
a differential value determine configured to determine a differential value from the second image for learning acquired by the learning converter and determine a differential value of a correct second image corresponding to the first image for learning; and
a learner configured to cause the conversion processing model to learn by associating the differential value of the second image for learning calculated by the differential value determiner, with the differential value of the correct second image determiner by the differential value determiner.

4. The image conversion model learning apparatus according to claim 3, wherein
the learner causes the conversion processing model to learn so as to reduce a loss function represented as a difference between the differential value of the second image for learning and the differential value of the correct second image.

5. A computer-implemented method for converting a first image into a second image having a higher resolution than the first image, the method comprising:
acquiring, by an acquirer, a first image to be converted; and
inputting, by a converter, the acquired first image to be converted to a conversion processing model for converting the first image into the second image, the conversion processing model being previously learned by associating a differential value acquired from a second image for learning output by inputting a first image for learning to the conversion processing model with a differential value acquired from a correct second image corresponding to the first image for learning to acquire the second image corresponding to the first image to be converted.

6. (canceled)

7. (canceled)

8. The image conversion apparatus according to claim 1, wherein the conversion processing model includes a convolutional neural network.

9. The image conversion model learning apparatus according to claim 3, wherein the conversion processing model includes a convolutional neural network.

10. The computer-implemented method according to claim 5, wherein the conversion processing model includes a convolutional neural network.

11. The computer-implemented method according to claim 5, wherein
the conversion processing model includes a model previously learned so as to reduce a loss function represented as a difference between the differential value of the second image for learning and the differential value of the correct second image corresponding to the first image for learning.
